(19) United States
(12) Patent Application Publication
(10) Pub. No.: US 2023/0241828 A1
(43) Pub. Date: Aug. 3, 2023

(54) Plastic and Wood Fiber Based Composite Product and Method and Apparatus for Manufacturing Said Plastic and Wood Fiber Based Composite Product

(71) Applicant: Aviplast WFC B.V., Lochem (NL)

(72) Inventors: Dirk Van Dijk, Lochem (NL); Albert Ten Busschen, Lochem (NL); Wilhelmus Johannes Maria Derksen, Lochem (NL)

(21) Appl. No.: 18/003,638

(22) PCT Filed: Jul. 15, 2021
(86) PCT No.: PCT/EP2021/069809

§ 371 Date: Dec. 28, 2022

(30) Foreign Application Priority Data
Jul. 16, 2020 (EP) 20186300.8

(51) Int. Cl. B29C 48/285; B29C 48/76; B29C 48/90; B29C 48/92; B27N 3/04; B27N 3/14

(52) U.S. Cl. CPC B29C 48/2886; B29C 48/767; B29C 48/90; B29C 48/92; B27N 3/04; B27N 3/143; B29C 2948/92019; B29C 2948/9238; B29C 2948/926; B29C 2948/92685; B29K 2023/12

(57) ABSTRACT

The present invention relates to a plastic based high density wood fiber composite (HDWFC) product and a method for manufacturing said composite product. The invention also relates to an apparatus for manufacturing said composite product.

### CROSS REFERENCE TO RELATED PATENT APPLICATIONS

This patent application claims priority from PCT/EP2021/069809, filed Jul. 15, 2021, which claims priority from European Patent Application 20186300.8, filed Jul. 16, 2020, which are hereby incorporated in their entirety by reference.

### FIELD OF THE INVENTION

The present invention relates to a plastic based composite product and a method for manufacturing said composite product. The invention also relates to an apparatus for manufacturing said composite product.

### BACKGROUND OF THE INVENTION

Plastic and wood fiber based composite (WFC) products are often used as alternative for wooden construction parts, in particular in buildings. For instance, such composite products can be used in wall structures, wall covering panels, and boards and railing systems. Such construction parts must have high strength, combined with low maintenance and have an appealing natural look. It is desirable that such composite products can be manufactured at low cost but which nevertheless meets high standards which may be required in respect of diverse properties. Such properties can relate for instance to mechanical properties, weather resistance, non-ageing properties and the like. An example of such a composite product is disclosed in EP 1 172 404 A1.

The inventors however concluded that there is room for improvement, in particular in view of condensing the product to a higher maximum density. Higher density on its turn is beneficial for durability, strength, stiffness and product stability, UV resistance and resistance to creep deformation.

### SUMMARY OF THE INVENTION

In a first aspect the invention relates to a plastic and wood fiber based composite product, which comprises a plastic in which wood fibers are homogeneously embedded in a mass percentage of 70-80% based on the total weight of plastic and wood fibers, wherein said fibers comprise large fibers with a dominant orientation in a chosen product principal direction and a length in the particle principal direction of about 2-6 mm and small fibers with a random orientation and a length smaller than the length of said large particles; wherein the capillaries of said wood fibers are filled with said plastic; and a moisture uptake after a 5 hours boiling test according to EN 1087-1 of 5% or less; and wherein the plastic and wood fiber based composite product has a density in kg/m³ of 95% or more of its maximum theoretical density. In view of this, the resulting product of the invention can be indicated herein as High Density Wood Fiber Composite (HDWFC).

The invention relates in a second aspect to a method for manufacturing a plastic and wood fiber based composite product by means of an extrusion process characterized by pushing the material to be extruded forward through an extruder, comprising:

I) feeding an agglomerate of said plastic and said wood fibers into the extruder, wherein the agglomerate comprises wood fibers in a mass percentage of 70-80% based on the total weight of plastic and wood fibers, wherein said fibers comprise large fibers with a dominant orientation in a chosen product principal direction and a length in the particle principal direction of about 2-6 mm and small fibers with a random orientation and a length smaller than the length of said large particles;

II) heating said agglomerate above the melting temperature of the plastic to plasticize the agglomerate to obtain a fluid material;

III) degassing the fluid material;

IV) while increasing pressure to at least 200 bar, mixing and dispersing the molten plastic around the wood fibers;

V) orienting the wood fibers to obtain a fluid mixture having orientated fibers, wherein said large fibers have a dominant orientation in a chosen product principal direction and said small fibers have a random orientation;

VI) shaping said fluid mixture having orientated fibers, followed by cooling to obtain a product with a solidified outer skin, wherein cooling takes place in a cooling die;

VII) wherein after the product exits the cooling die it enters a product condensing die, configured to condense and support the product and in which a backward compressive force is exercised on the product exiting the cooling die to obtain the pressure of at least 200 bar in step IV). This method suitably results in the plastic and wood fiber based composite product of the first aspect.

The invention relates in a third aspect to an apparatus for manufacturing a plastic and wood fiber based composite product, which apparatus comprises an extruder and dies, and which has the following configuration:

a heating and plasticizing zone configured to heat an agglomerate of said plastic and said wood fibers to obtain a fluid material of molten plastic and wood fibers;

means to push the fluid material forward through the extruder;

a degassing zone downstream of said heating and plasticizing zone and configured to degas the fluid material;

a pressure increasing extrusion zone downstream of said degassing zone, and configured to mix and disperse the molten plastic around and into the wood fibers; and to obtain a fluid mixture of plastic and wood fibers at a pressure of at least 200 bar;

an orientation zone comprising an orientation die which is configured to orientate the long fibers in the mixture by means of spiders and to create a plug flow of the mixture,

a heated shaping die downstream of the orientation zone, and configured to shape said fluid mixture having orientated fibers and maintaining the plug flow,

a cooling die downstream of said heated shaping die and configured to cool the outer skin of said fluid mixture having orientated fibers in a plug flow manner, to obtain a semi solidified product having a solidified outer skin;

a condensing die downstream of the cooling die and configured to support the semi solidified product when a backwards pushing compressive force is exerted on the semi solidified product;

a compression control unit downstream of the condensing die and configured to exert a backwards pushing compressive force on the semi solidified product so as to create an upstream increase of mixture pressure. By the action of said compression control unit the increase in mixture pressure may be effected up to the end of the degassing zone. This apparatus can be suitably used to manufacture the plastic and wood fiber based composite product of the first aspect, suitably by means of the method of the second aspect.

The inventors have found that the use of a relatively high percentage of wood fibers of 70 to 80% based on the total weight of plastic and wood fibers in combination with filling of the capillaries of said wood fibers with said plastic while the wood fibers remain intact with respect to their pre-filling state, provides a composite product with a moisture uptake after a 5 hours boiling test according to EN 1087-1 of 5% or less and a density in kg/m³ of 95% or more of its maximal theoretical density. This product has a high density and is improved with regard to prior art wood fiber plastic based composite products with respect to outside durability and natural UV resistance, strength, stiffness, product stability and creep deformation.

The inventors have found that such a product is obtainable with the method of the invention. The method of the invention allows to fill the capillaries of said wood fibers with plastic while the wood fibers remain intact with respect to their pre-filling state such that an essentially void free product is obtained. This is associated by the provision of a step of exercising a compressive backward force to the product as it exits the cooling die. This additional back pushing force allows to achieve a higher pressure in step IV) of mixing and dispersing the molten plastic around and into the wood fibers. As a result, any void left after the degassing step III) is pushed out of the wood fibers while the wood fibers retain their shape and an essentially void free product is obtained with high density and the abovementioned further advantageous characteristics. The absence or near absence of any voids is reflected by the products low moisture uptake after a 5 hours boiling test according to EN 1087-1 of less than 5%. Exercising a compressive backward force to the product, as it exits the cooling die, would lead to buckling or deformation of the product as it exits the cooling die if no measures were taken, in particular because the inside of the product is in general not yet solidified as it exits the cooling die. The provision of the condensing die downstream of the cooling die, which by means of design also supports the product in process, avoids this and allows to exercise the back pushing compressive backward force without the risk of buckling or collapse of the product.

### BRIEF DESCRIPTION OF THE DRAWINGS

FIG. 1 shows a schematic representation of an embodiment of the apparatus according to the invention with a diagram which represents the pressures (bar) in the various sections of the apparatus.

FIG. 2 shows a diagram of composite density in dependency of various pressures applied by compression molding.

FIG. 3 shows wood product composite voids in a conventional wood fiber composite (WFC) (FIG. 3A) and filled voids in a wood fiber composite according to the invention (HDWFC) (FIG. 3B).

### DETAILED DESCRIPTION OF THE PREFERRED EMBODIMENT

The plastic and wood fiber based composite product according to the invention comprises a plastic in which wood fibers are homogeneously embedded in a mass percentage of 70-80% based on the total weight of the wood fibers and the plastic in which the wood fibers are embedded contained in the product. This total weight excludes other additives such as reinforcements, fillers, or the like.

The plastic is a thermoplastic polymer, such as a bio based thermoplastic polymer.

Preferred thermoplastic polymers may be homo or co-polymers of polypropylene (PP), polyethylene (PE), polyvinylchloride (PVC), polystyrene (PS), poly(methyl methacrylate) (PMMA), polylactic acid (PLA) or a combination thereof. Such plastics have been proven successful fiber binders in the art of plastic and wood fiber based composite product(s). Recycled plastics can also be used as a fiber binder. Further improvement of material binding performance may be achieved by the addition of so-called coupling agents.

The wood fibers may be derived from any source of wood, including recycled wood. Particular suitable wood sources include without limitation coniferous wood, such as pine or spruce, or firs, or broad leaved (deciduous) wood species such as birch and poplar. The fibers can be from a single source or a mixture of fibers of different origin.

The fibers in the composite product of the invention comprise large fibers with a dominant orientation in a chosen product principal direction and a length in the particle principal direction of 2-6 mm and small fibers with a random orientation and a length smaller than the length of said large particles. The length of the large fibers, in the range of 2-6 mm, is important in order to reach the desired characteristic with regard to strength, stiffness and to obtain a natural look. Moreover it is important that these fibers have a large length as compared to the diameter to ensure a sufficient length/diameter (L/D) ratio for mechanical strength in relation to the volume of fibers by weight of product. Suitable L/D ratios in this respect may range from 4 to 40, more preferably from 4 to 20. The small fibers preferably have a length in the particle principal direction of at least 0.5 mm. On the other hand the small fibers preferably have a length in the particle principal direction of less than 2 mm.

In order to provide sufficient strength it is preferred that the oriented fibers, i.e. the large fibers are present in a percentage of at least 25% by weight in relation to the total weight of the fibers, preferably more than 50% preferably more than 60%. Optimal results are obtained when the long fibers contain more than 60% by weight in relation to the total weight of the fibers.

In the composite product of the invention, the capillaries of said wood fibers are filled with said plastic. That means that voids between the fibers, but also crevices and intercellular voids or spaces in the fibers and even intracellular voids are filled with plastic. Due to the measures taken in the method of the invention the wood fibers retain their shape with respect to their pre-filling state even though they are exposed to high pressure differences. The result is that the composite product is essentially or even completely void free, which is reflected in the fact that it has a moisture uptake after a 5 hours boiling test according to EN 1087-1 of 5% or less, such as 4% or less and in that it has a density in kg/m³ of 95% or more of its maximal theoretical density. It is preferred in this respect that, in the composite product according to the invention, the wood fibers embedded in the plastic are void free as determined by Scanning Electron Microscopy and/or Energy Dispersive X-Ray (SEM/EDX) analysis.

The plastic binds the fibers. It is preferred that the amount of plastic is as low as possible without detrimental effects on the strength, stability, and stiffness of the product. This is advantageous for reasons of the environment, cost price and it also contributes to the natural look of the product as the composite product will have close similarity to natural wood products and good adhesion for paints and glues. It is therefore preferred that wood fibers are embedded in said plastic in an abutted fashion at least along the dominant orientation. This is made possible by the present invention due to the increased, high pressure in step IV) when mixing and dispersing the molten plastic around and into the wood fibers takes place, in combination with the high amount of wood fibers with respect to the amount of plastic. In this way it becomes possible that the plastic penetrates in the voids, thus providing strength, stability and rigidity to the product. This allows that only the plastic necessary to bind the fibers with each other needs to be present between fibers.

The composite product of the invention has a density in kg/m³ of 95% or more of its maximum theoretical density, preferably a density in kg/m³ of 96% or more of its maximal theoretical density, even more preferably 97% or more, such as 98% or more.

The maximal theoretical density of a wood fiber composite product is the density that said wood fiber composite product would have if it would have the same composition without voids.

This theoretical density can be calculated as follows: The wood fiber plastic composite can be considered as a composite product that contains wood fibers (f) that are embedded in a plastic matrix (m). In this situation further components in the product are not included in the calculation. In other words, the maximal theoretical density in this calculation relates to the density of the plastic in which said wood fibers are homogeneously embedded. Consequently, this method is applicable to products that do not contain further components except for the plastic and fibers. It is further assumed that there are no voids (porosities). In that case the fiber volume fraction (v_{f}) can be expressed in the component mass fractions (m_{f} and mₘ) and component densities (ρ_{f} and ρₘ) in the following manner:

v_{f}=m_{f}ρₘ/(m_{f}ρₘ+mₘρ_{f}) (Formula 1)

Because there are no other components (and thus no porosities) the following assumptions are made:

v_{f}+vₘ=1 and m_{f}+mₘ=1 (Formulas 2 and 3)

From the component volume fractions and the component densities the maximal theoretical density can be calculated:

ρ_{c}=v_{f}ρ_{f}+vₘρₘ (Formula 4),

wherein
ρ_{c} is the maximal theoretical density in kg/m³
v_{f} is the fiber volume fraction in %
ρ_{f} is the fiber density in kg/m³
vₘ is the plastic volume fraction in %
ρₘ is the plastic density in kg/m³.

This formula gives the maximum theoretical density (ρ_{c}) of a composite product in which no voids (porosities) are present.

If the wood fiber plastic composite contains wood fibers (f) that are embedded in a plastic matrix (m) and optional additional components (add) such as reinforcement elements, a maximum theoretical density (ρ_{c}) may alternatively be calculated follows:

ρ_{c}=v_{f}ρ_{f}+vₘρₘ+v_{add}ρ_{add} (Formula 5),

wherein,
ρ_{c} is the maximal theoretical density in kg/m³
v_{f} is the fiber volume fraction in %
ρ_{f} is the fiber density in kg/m³
vₘ is the plastic volume fraction in %
ρₘ is the plastic density in kg/m³.
v_{add} is the total volume fraction of additional components in %
ρ_{add} is the total average density of additional components in kg/m³.

In this case the density of the wood fiber plastic composite product and the maximal theoretical density take additional components into account. In this calculation method the wood fiber plastic composite product including any additional components is taken as the basis for calculating the maximal theoretical density. Consequently, the actual density of the product is also determined with inclusion of said additional components. Of course, formula 5 may also be used for products that do not include additional components.

For example, for the combination of spruce as wood fiber and PP as a thermoplastic matrix the calculation of the maximum attainable density is calculated as follows: First the density of the wood fiber without voids is determined:

ρ_{f}=1450 kg/m³

This is the weighed density of the densities of 40% cellulose, 30% hemicellulose (both 1500 kg/m³) and 25% lignin (1300 kg/m³) of which the cell wall of coniferous wood (like pine or spruce) is composed. The other necessary parameters for the calculation are:

ρₘ=900 kg/m³

This is the density of PP.

m_{f}=0.73=73%

A percentage of 73% wood fiber by weight of the total composite product is used in this example

Then Formula 1 is used:

v_{f}=0.626=62.6%

Then, using Formulas 2, 3, and 4 the maximum theoretical density can be calculated as:

ρ_{c}=1245 kg/m³

In a very suitable composite product the plastic is polypropylene and the density of said composite product is between 1200 and 1220 kg/m³. In the specific case where the density of 1220 kg/m³ has been measured, this is 98% of the maximum theoretical density of 1245 kg/m³. In another very suitable composite product the plastic is polyvinylchloride and the density of said composite product is between 1400 and 1420 kg/m³. These composite products comply with all requirements for construction purposes.

In terms of appearance and weight of the product in accordance to the invention, the composite product can, if desired, display a striking similarity with natural wood or wood based products.

The product according to the invention can be machined with normal wood working tools and normal wood processing machines. The behaviour of the material is comparable to hard wood. In the usual manner of hard wood it can be nailed, sawn, screwed, glued, painted and lacquered.

In the composite product of the invention, further additives may be present that fulfil an additional function with respect to the main material of the profile.

In a preferred embodiment the product contains reinforcement elements, preferably reinforcement elements of metal, natural material or synthetic material in order to provide a reinforced profile. Such reinforcements elements can be included into the product by taking the measures disclosed EP 1 610 938 B1, the teachings thereof in this respect being incorporated into this application by reference. Such reinforced profiles may for instance be used as supporting framework on which a floor or terrace is mounted by means of nails or screws or profiles for window or door frames.

The composite product according to the invention may suitably be a construction element selected from an I-profile, H-profile or another profile comprising a body and legs or arms or flanges that are protruding therefrom or a construction element having the shape of a hollow or tubular profile.

The composite product according to the invention is suitably obtainable by the method of the invention and by means of the apparatus of the invention. The features discussed in regard of the apparatus may also be applicable for the method and vice versa.

The method of the invention involves an extrusion process characterized by pushing the material to be extruded forward through an extruder and dies. The method according to the invention involves a shaping process under significant overpressure, wherein the material is pushed forward as a plug (plug flow) through dies for respectively orientation, shaping, cooling and condensing.

For this purpose the extruder is provided with a means to blend and push the fluid material forward through a pressure increasing extrusion zone, a heated shaping die, a cooling die, and a condensing die attached to the extruder. Such an extrusion process is also referred to as pushtrusion. The means to push the fluid material forward may suitably include a driving screw or screws that is/are driven by a motor. This may for instance be a co-rotating twin-screw configuration that is driven by an electromotor.

The extruder is fed with an agglomerate of said plastic and said wood fibers. The agglomerate can be made upstream of the extrusion part of the apparatus and in the same apparatus. Accordingly, the apparatus also may include a device for preparing agglomerates. Alternatively the agglomerate can be made in a separate set-up. In the latter case the apparatus does not include a device for preparing agglomerates. In this regard, if the compounding process and the extrusion process are coupled, the method may include the optional step of preparing an agglomerate of said plastic and said wood fibers prior to the above defined step I). If the compounding process and the extrusion process are not coupled, the step of preparing an agglomerate of said plastic and said wood fibers may be performed prior to the above defined step I) separate of the method of the invention.

Agglomerates can be made by compounding a suitable mixture of plastic and wood fibers. To ensure efficient compounding, the wood fibers are preferably dried to moisture content of below 0.3% by mass and are then compounded into an agglomerate with the plastic. A suitable compounder, including a wood drying and compounding process may involve the use of a screw compounder, for instance as described in WO 2012/072275 A1 (US2014027937 A1, U.S. Pat. No. 9,440,374 B2), the contents in this respect being incorporated in this application by reference.

The agglomerate of plastic and wood fibers is fed into the extruder for instance into a barrel via a feed inlet provided on a top portion of the extruder. From this position the agglomerate is pressed forward to a heating and plasticizing zone configured to heat an agglomerate of said plastic and said wood fibers to obtain a fluid material. Here the agglomerate is heated above the melting temperature of the plastic to plasticize the agglomerate to obtain a fluid material and the pressure is preferably increased to enhance plasticization, for instance up to 150 bar. The temperature used is preferably above 200° C., preferably for a short time of shorter than 5 minutes, more preferably shorter than 2 minutes, in order to prevent or reduce degradation of the wood fibers.

After the material is uniformly heated and plasticized, the fluid material is degassed in a degassing zone downstream of said heating and plasticizing zone and configured to degas the fluid material. The high temperature of the molten material, preferably on or 10° to 30° C. above the melting point of the plastic used, enables to extract under a vacuum, free and entrapped expanded air and gas in pores and cavities, whereas the molten and highly fluidised plastic is sucked into the capillary of the wood fibers by capillary action of the resin. There should not be any pressure in the centre of this zone of the extruder as this step takes place under a vacuum.

Next the material is passed to a pressure increasing extrusion zone downstream of said degassing zone, where the pressure is rapidly increased to enhance the capillary filling of the wood fiber cavities and press out all remaining voids. This zone is further configured to mix and disperse the molten plastic into and around the wood fibers, and to push the material further into dies including a condenser die at increasing pressure of up to at least 200 bar. This increasing pressure also results in increased pressure at the end of the degassing zone which further optimizes elimination of any voids. As a result any void left after the degassing step is pushed out of the wood fibers while the wood fibers retain their shape and an essentially void free product is obtained with high density and the abovementioned further advantageous characteristics.

The pressure in the pressure increasing zone is also partially effected by the orientation zone downstream thereof. This orientation zone comprises an orientation die configured to orientate the large fibers under further increasing of pressure to obtain a fluid mixture having orientated fibers in a plug-flow manner, wherein said large fibers have a dominant orientation in a chosen product principal direction and said small fibers have a random orientation. The fibers are oriented by means of so-called spiders comprising several legs in the direction of extrusion. Such spiders are well known in the art of extrusion. A so-called spider die comprises a mandrel connected to the outer die wall by several legs in the direction of extrusion. This way the spider legs will maintain and enhance fiber orientation and contribute to the high pressure downstream of the degassing zone.

Optimal results are obtained in this respect when the pressure is increased to a pressure of 220-230 bar. It is therefore preferred that the pressure is increased in step IV) to a pressure of 220-230 bar. The pressure increase downstream of the degassing zone is facilitated by the back pushing compressive force exercised on the product in the condenser die upon exiting the cooling die as will be further explained below. This pressure is preferably maintained up to step VI).

After passing the orientation die, the fluid mixture with orientated fibers is pushed into a heated shaping die to shape said fluid mixture. In this stage the fluid mixture with orientated fibers is shaped to a desired shape. Here the product profile shape is formed while maintaining a flow of the material. As the material is pushed forward as a plug of molten material this flow is also referred to as “plug flow”.

After passing the heated shaping die the shaped liquid profile is passed to a cooling die downstream of said heated shaping die and configured to cool the outer skin of said fluid mixture having orientated fibers to obtain a semi-solidified product with a solidified outer skin. Here the outer skin of the shaped fluid mixture is cooled to obtain a product with a solidified outer skin. It is important here that after shaping, the skin of the liquid mixture is cooled under pressure to below the Vicat softening temperature of the plastic binder. This consolidation process is necessary to prevent delamination and matrix failure. This way the product skin is formed. The product skin gives some rigidity to the profile when it exits the cooling die. This makes it possible to apply a compressive force on the profile as it exits the die.

Namely, after the product exits the cooling die it enters a product condensing die configured to condense and support the product and in which a compressive backward force is exercised on the product exiting the cooling die to obtain the pressure of at least 200 bar in step IV) of the method of the invention, i.e. downstream of the degassing zone. The increasing pressure in the pressure increasing zone is this way created by the condenser die in combination with the fiber orientation die. This condenser die, located downstream of the cooling die, is configured to condense and support the product to an increased product density, while a compressive backward force is exercised on the product exiting the cooling die to obtain the pressure of at least 200 bar. This way directly after the degassing zone a pressure in the extrusion zone of at least 180 to 200 bar is obtained and which rapidly increase above 200 bar in a downstream fashion. In order to achieve these high pressures a compressive force acts on the product that exits the cooling die. The product exiting the cooling die would be too weak to sustain this compressive force without buckling or deformation. This is prevented by the provision of the condensing die which is placed around the product once the extrusion process is running and supports the product to maintain its shape and to prevent buckling or deformation.

The high pressure of above 200 bar is essential for the realization of a practically void-free wood fiber composite material with a high density (HDWFC). However, to obtain this by a classical set-up of an extruder in combination with directly mounted dies would give the drawback of excessive fiber damage because the screws must completely generate the pressure build up, resulting in excessive fiber breakage. In such a classical set-up the high density would be attained but the material would not have good mechanical performance anymore. The invention described herein enables that the pressure build up is partly realized by a backward compressive force so that the pressure build up in the screws is on such a level that the fiber length of the reinforcing wood particles stays intact. In this manner both a high density and a material with good mechanical performance is achieved.

The backward pushing compressive force can suitably be realised by a combination of friction generated by the condenser die that is clamped around the exiting product and a controlled compressive force that is generated by a force-controlled guiding mechanism further downstream. This can be realized by means of a compression control unit which is configured to apply a back pushing force to the shaped and cooled product back in the direction of the extruder. On the other hand it may be configured to apply a pulling force in a start-up phase of the method. In an exemplary embodiment, the compression control unit is configured as a caterpillar unit, wherein caterpillars on opposite sides of the shaped and cooled product, or more sides depending on the product shape, exert a counterforce in upstream direction to as to provide counter pressure.

The backward pushing compressive force can suitably be realized by applying a counter pressure of between 25 and 80 bar, such as 50 bar. The counter pressure may be increased or decreased throughout operation of the process depending on the desired settings. For this purpose a density control system may be used which is configured to control process parameters and/or settings of the various apparatus parts.

In a phase of starting up the method, the product condenser die is not placed around the product yet and the product can exit the cooling die without compressive force or applying friction. Once the process is running the condenser die is placed (fully closed, see closed line 18) around the product and the back pushing compressive force can be applied by the compression control unit. In order to allow quick and easy placement and removal, the product condensing die is preferably configured as a collapsible die.

It is preferred that the apparatus comprises a density control system connected with a pressure sensor inside the entry of the fiber orientation die and with a means for driving the extruder. This enables speed and pressure constancy in the extruder. For instance, if the pre-set compound pressure drops, the system will give command to the extruder to increase the output of product and during start-up of the process, the system may command the compression control unit, to increase pulling or haul of speed.

### EXAMPLES

The following examples and explanation are meant to illustrate the invention and not to limit the scope of the invention.

### Example 1—Exemplary Apparatus

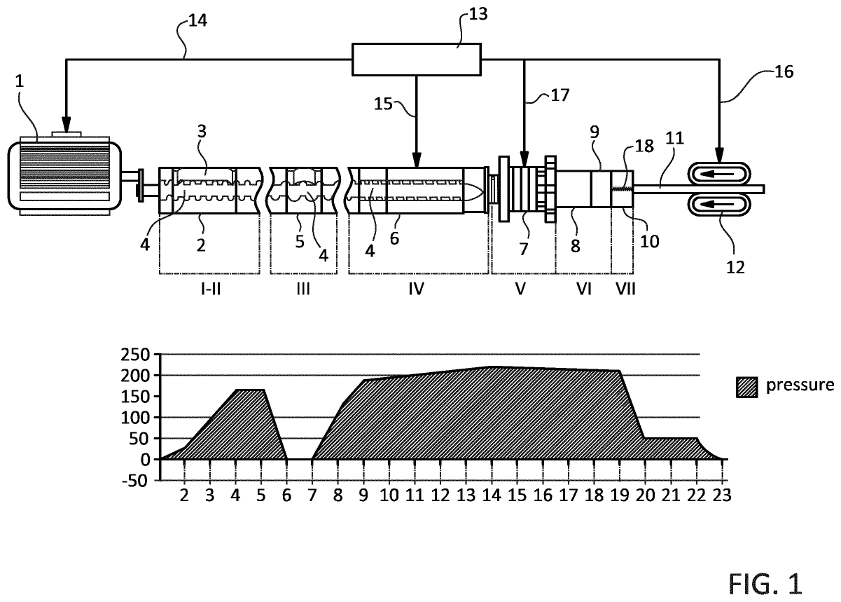

FIG. 1 shows a schematic representation of an embodiment of the apparatus according to the invention with a diagram which represents the pressures in the various sections of the apparatus. In FIG. 1 an extruder is shown with a co-rotating twin-screw 4 that is driven by an electromotor 1. An agglomerate of plastic and wood fibers is fed into the extruder for instance into a barrel via a feed inlet 3 provided on a top portion of the extruder.

From this position the agglomerate is passed forward by means of twin-screw 4 to a heating and plasticizing zone 2 configured to heat an agglomerate of said plastic and said wood fibers to obtain a fluid material. Here the agglomerate is heated above the melting temperature of the plastic to plasticize the agglomerate to obtain a fluid material. This temperature is preferably above 200° C., preferably for a duration shorter than 5 minutes, more preferably shorter than 2 minutes, in order to prevent or reduce degradation of the wood fibers, and the pressure is increased up to about 170 bar as shown between point 2 and 5 of the horizontal axis of the pressure diagram.

After the material is uniformly heated and plasticized, the fluid material is degassed in a degassing zone 5 downstream of said heating and plasticizing zone 2 and configured to degas and make possible to have the fluid material penetrate into the capillaries of the wood fibers by capillary action. As shown in the graph this is accompanied with a pressure drop starting at point 5 of the horizontal axis of the diagram. As can be seen between points 6 and 7 of the horizontal axis of the pressure diagram the pressure drops here to zero.

Next the material is passed to a rapid pressure increasing extrusion zone 6 downstream of said degassing zone 5, to fully fill the wood fiber capillaries with the resin under a combination of capillary action and squeezing of the fibers and further configured to mix and disperse the molten plastic around and into the wood fibers and to facilitate a downstream pressure increase up to 220 and 230 bar. Here the molten plastic is further mixed and dispersed around the wood fibers. As a result any void left after the degassing step is pushed out of the wood fibers while the wood fibers retain their shape and an essentially void free product is obtained with high density. See in this regard the pressure increase starting at point 7 to 9 of the horizontal axis of the pressure diagram. The pressure increases here gradually to 190 Bar. In this example the pressure further increases to approximately 230 bar from point 9 to 14 by reduced screw volume followed by slightly reducing the pressure to approximately 220 bar from point 14 to 19 as shown in the pressure diagram.

After passing the pressure increasing extrusion zone 6, the fluid mixture is pushed forward into the orientation die 7 configured to orientate the long fibers by means of spiders, after which the oriented mixture is pushed in a plug flow manner into a heated shaping die 8, which is configured to shape said fluid mixture into a desired profile shape and under a pressure of approximately 220 bar shown in the pressure diagram at point 18 to 19.

After passing heated shaping die 8 the shaped liquid profile is passed to a cooling die 9 downstream of said heated shaping die. This cooling die 9 is configured to cool the outer skin of the product to obtain a product with a solidified outer skin. This product skin gives some rigidity to the profile when it exits the cooling die at a pressure of 220 bar.

After the product exits the cooling die 9 it enters a product condensing die 10 configured to condense and support the product at a pressure of 220 bar on entry, reducing to 50 bar on exit of the product as shown between points 19 to 20 in the pressure diagram and in which a compressive backward force of approximately 50 bar is exercised by means of compression control unit 12, as shown in the pressure diagram at points 20 to 22. After passing the compression control unit 12 the pressure becomes zero between points 22 and 23. The compression control unit is configured as a caterpillar unit, wherein caterpillars on opposite sides of the product, or more sides depending on the product shape, exert a counter force in upstream direction to as to provide counter pressure on the product exiting the cooling die to obtain the pressure of at least 200 bar, preferably between 220-230 bar, in the pressure increasing extrusion zone 6.

The backward pushing compressive force realizing the quick increasing high pressure in zone 6 of the extruder and increasing as shown in the pressure diagram between points 7 to 9 and slightly increasing further between points 9 to 14 is realized by friction in the condenser die in combination with a pressure or compression control unit 12 which is configured to apply a back pushing force to the shaped and cooled product 11 back in the direction of the extruder and in the condenser unit (see the arrows). This unit is placed around the exiting profile and configured to clamp around the exiting product while the compression control unit 12 exercises a back pushing force.

The Roman numbers I-VII in FIG. 1 represent the approximate locations in the apparatus of FIG. 1 where the above defined respective process steps I-VII take place.

The apparatus of FIG. 1 further comprises a density control system 13 in communication (arrow 17) with a pressure sensor inside the orientation die 7, the compression control unit (arrow 16) and in communication (arrow 14) with the electromotor 1. This enables speed and pressure constancy in the proposed extrusion system. For instance, if the compound pressure drops, the system 13 will give command to the extruder to increase the output of product and during start-up of the process, the system may command the compression control unit, to increase pulling or haul of speed. Similarly, the density control system 13 may be in communication with the pressure increasing extrusion zone 6 (arrow 15) and compression control unit 12 (arrow 16) in order to check, control and adjust process parameters in a pre-programmed automatic manner.

### Example 2—Benefits of a Composite Product According to the Invention

The benefits found for the composite product according to the invention as obtained with the apparatus of example 1 are confirmed with tests that were performed with the following wood fiber plastic composition:

Spruce fibers: 73% by mass (at least 60% based on total weight of fibers of large fibers of a length in the particle principal direction of about 2-6 mm), polypropylene-based polymer: 27% by mass.

The measured density was 1220 kg/m³

This material is compared with wood fiber composite material that was made with prior art technology which measured densities that range between 1100 and 1150 kg/m³, also with 73% spruce by mass and 27% polypropylene-based polymer by mass.

The material according to the invention is referred to as High Density Wood Fiber Composite (HDWFC). The prior art material is referred to as Wood Fiber Composite WFC.

The following results were obtained.

1. Outside durability and natural UV resistance

A durability class 1 for soil contact (according to EN 305-1) was measured for HDWFC. For the WFC durability classes for soil contact have been determined that range between 2 and 3, according to EN 305-1.

2. Higher strength, stiffness, and product stability

A bending strength (MOR) of 75 MPa and bending stiffness (MOE) of 7500 MPa have been measured for HDWFC. For the WFC has been reported values: MOR=32 MPa, MOE=3849 MPa.

3. Lower creep deformation. From creep tests in a dead-weight 3-point bending configuration it is found that the development of creep deformation for HDWFC is at a three times slower pace than for WFC under the same conditions of loading and temperature.

4. The moisture uptake after the 5 hours boiling test according to EN 1087-1 was 3 to 5% for HDWFC. For WFC the moisture uptake with this test generally ranges between 6% and 8%.

### Example 3—Density of a Composite Product as a Function of Applied Pressure

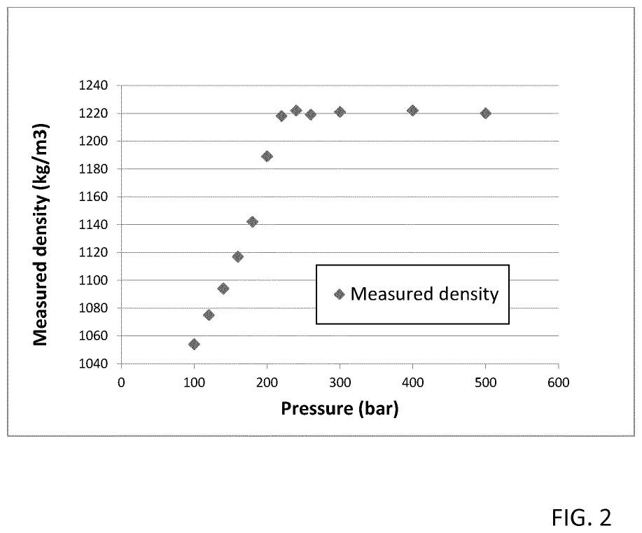

When a composition as shown in example 2 is compressed in a heated press the maximum attainable density or maximum theoretical density can be determined. For this at different pressure levels, the density of the compressed material has been measured. It appears that above a pressure of about 220 bar the density does not increase further (pressures up to 540 bar have been tested). FIG. 2 shows a diagram of composite density in dependency of various pressures applied when compression moulding.

The maximum density that was measured was: ρc=1220 kg/m³.

This is very close (98%) to the maximum theoretical density of a compound with this composition (1245 kg/m³). This small difference of 2% can have different origins:
Accuracy of the known densities of the components.
Effect of neglected components (e.g. wood extractables).
Accuracy of the percentage of wood fibers in the compound.

FIG. 2 shows that the desired density in kg/m³ of 95% or more of its maximal theoretical density could be obtained when the pressure was increased up to more than 200 bar. Because the density did not increase substantially above 220 bar, it was concluded that an optimal pressure to be reached in step IV) up to step VI) may be set at 220 to 230 bar.

### Example 4—Scanning Electron Microscopy/Energy Dispersive X-Ray (SEM/EDX) Analysis

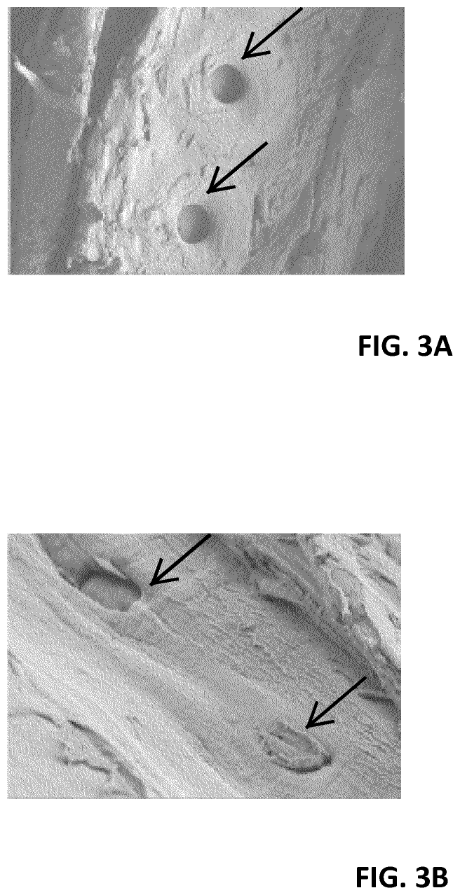

Scanning Electron Microscopy/Energy Dispersive X-ray (SEM/EDX) analysis was carried out on fibers of a prior art product produced at a lower pressure in the production of WFC (Wood Fiber Composite) without the proposed condensing system of the invention (3A) and on a High Density Wood Fiber Composite product (HDWFC) in accordance with the invention as described in Example 2. For this purpose the wood fibers were extracted from extruded WFC and HDWFC produced products and analysed. Fiber samples were secured on an aluminum holder with carbon tape; they were analysed with SEM-EDX. EDX spectra were taken with a take-off angle of app. 39.5° and a maximum accelerating voltage of 2.40 keV; SEM/EDX measurements were performed on a Zeiss 1550 FEGSEM coupled with a Noran Vantage 5000 series EDX system. Prior to SEM-EDX experiments the sample was cut in half to analyse the sample more accurately, since the geometry was unfavourable for the experiments. The wood fibers in both production methods were well compounded and dispersed in the polypropylene and the polypropylene filled the capillaries of the wood fibers differently. This is envisaged in FIG. 3, wherein the arrows point at the capillaries. FIG. 3A shows a fiber in a conventional WFC product with open capillaries. FIG. 3B shows a fiber in a HDWFC product produced in accordance with the invention. It clearly shows that the capillaries of the fiber shown in FIG. 3B are filled with polypropylene.

While this invention has been described with reference to preferred embodiments thereof, it is to be understood that variations and modifications can be affected within the spirit and scope of the invention as described herein and as described in the appended claims.

1. A plastic and wood fiber based composite product, which comprises a plastic in which wood fibers are homogeneously embedded in a mass percentage of 70-80% based on the total weight of plastic and wood fibers, wherein said fibers comprise
large fibers with a dominant orientation in a chosen product principal direction and a length in the particle principal direction of about 2-6 mm; and
small fibers with a random orientation and a length smaller than the length of said large particles;
wherein the capillaries of said wood fibers are filled with said plastic; and wherein the plastic and wood fiber based composite product has a moisture uptake after a 5 hours boiling test according to EN 1087-1 of 5% or less; and wherein the plastic and wood fiber based composite product has a density in kg/m³ of 95% or more of its maximal theoretical density, wherein the maximal theoretical density of said wood fiber composite product is the density that said wood fiber composite product would have if it would have the same composition without voids.

2. The plastic and wood fiber based composite product according to claim 1, wherein the product consists of plastic and wood fibers and wherein the maximal theoretical density of the plastic and wood fiber based composite is as calculated in accordance with the following formula:
ρ_{c}=v_{f}ρ_{f}+vₘρₘ (Formula 4),
wherein ρ_{c} is the maximal theoretical density in kg/m³
v_{f} is the fiber volume fraction in %
ρ_{f} is the fiber density in kg/m³
vₘ is the plastic volume fraction in %
ρₘ is the plastic density in kg/m³.

3. The plastic and wood fiber based composite product according to claim 1, wherein said plastic is polypropylene and the density of said composite product is between 1200 and 1220 kg/m³.

4. The plastic and wood fiber based composite product according to claim 1, wherein said plastic is polyvinylchloride and the density of said composite product is between 1400 and 1420 kg/m³.

5. The plastic and wood fiber based composite product according to claim 1, wherein the product comprises additional components and the maximal theoretical density of the plastic and wood fiber based composite product is as calculated in accordance with the following formula:
ρ_{c}=v_{f}ρ_{f}+vₘρₘ+v_{add}ρ_{add} (Formula 5),
wherein ρ_{c} is the maximal theoretical density in kg/m³
v_{f} is the fiber volume fraction in %
ρ_{f} is the fiber density in kg/m³
vₘ is the plastic volume fraction in %
ρₘ is the plastic density in kg/m³.
v_{add} is the total volume fraction of additional components in %
ρ_{add} is the total average density of additional components in kg/m³.

6. The plastic and wood fiber based composite product according to claim 5, wherein said additional components comprise reinforcement elements, preferably reinforcement elements of metal, natural or synthetic material.

7. The plastic and wood fiber based composite product according to claim 1, wherein said plastic is a thermoplastic polymer, preferably a bio based thermoplastic polymer, preferably wherein the plastic contains at least one polyolefin, such as homo or co-polymers of polypropylene, polyethylene, polyvinylchloride, or polystyrene; or poly(methyl methacrylate) (PMMA), polylactic acid (PLA); or a combination thereof.

8. The plastic and wood fiber based composite product according to any of the previous claims, wherein said small fibers have a length in the particle principal direction of at least 0.5 mm.

9. The plastic and wood fiber based composite product according to claim 1, which has a density in kg/m³ of 96% or more of its maximum theoretical density, preferably 97% or more such as 98% or more.

10. The plastic and wood fiber based composite product according to claim 1, wherein the wood fibers embedded in the plastic are void free as determined by Scanning Electron Microscopy and/or Energy Dispersive X-Ray (SEM/EDX) analysis.

11. The plastic and wood fiber based composite product according to claim 1, wherein said wood fibers are embedded in said plastic in an abutted fashion at least along the dominant orientation.

12. The plastic and wood fiber based composite product according to claim 1, which is a construction element selected from an I-profile, H-profile or another profile comprising a body and legs or arms or flanges that are protruding therefrom or a construction element having the shape of a hollow or tubular profile.

13. Method A method for manufacturing a plastic and wood fiber based composite product according to claim 1 by means of an extrusion process characterized by pushing the material to be extruded forward through an extruder, comprising
I) feeding an agglomerate of said plastic and said wood fibers into the extruder;
II) heating said agglomerate above the melting temperature of the plastic to plasticize the agglomerate to obtain a fluid material;
III) degassing the fluid material such to make capillary action possible so that fluid plastic material fills the capillaries of the wood fibers;
IV) while increasing pressure to at least 200 bar, mixing and dispersing the molten plastic around the wood fibers;
V) orienting wood fibers to obtain a fluid mixture having orientated fibers, wherein said large fibers have a dominant orientation in a chosen product principal direction and said small fibers have a random orientation;
VI) shaping said fluid mixture having orientated fibers, followed by cooling to obtain a product with a solidified outer skin, wherein cooling takes place in a cooling die;
VII) wherein after the product exits the cooling die it enters a product condensing die, configured to condense and support the product and in which a backward compressive force is exercised on the product exiting the cooling die to obtain the pressure of at least 200 bar in step IV).

14. The method according to claim 13, wherein in step IV) the pressure is increased to a pressure of 220-230 bar.

15. The method according to claim 13, which further comprises a step of preparing an agglomerate of said plastic and said wood fibers prior to step I).

16. The plastic and wood fiber based composite product according to claim 1, which is obtainable by the method according to claim 13.

17. An apparatus for manufacturing a plastic and wood fiber based composite product according to claim 1, which apparatus comprises an extruder and dies, and which has the following configuration:
a heating and plasticizing zone configured to heat an agglomerate of said plastic and said wood fibers to obtain a fluid material of molten plastic and wood fibers;
means to push the fluid material forward through the extruder;
a degassing zone downstream of said heating and plasticizing zone and configured to degas the fluid material and fill the capillaries of the wood fibers with said molten plastic;
a pressure increasing extrusion zone downstream of said degassing zone, and configured to mix and disperse the molten plastic around and into the wood fibers; and to obtain a fluid mixture of plastic and wood fibers at a pressure of at least 200 bar;
an orientation zone comprising an orientation die which is configured to orientate the long fibers in the mixture by means of spiders and to create a plug flow of the mixture,
a heated shaping die downstream of the orientation zone, and configured to shape said fluid mixture having orientated fibers and maintaining the plug flow,
a cooling die downstream of said heated shaping die and configured to cool the outer skin of said fluid mixture having orientated fibers in a plug flow manner, to obtain a semi solidified product having a solidified outer skin;
a condensing die downstream of the cooling die and configured to support the semi solidified product when a backwards pushing compressive force is exerted on the semi solidified product;
a compression control unit downstream of the condensing die and configured to exert a backwards pushing compressive force on the semi solidified product so as to create an upstream increase of mixture pressure.

18. The apparatus according to claim 17, comprising a density control system connected with a pressure sensor inside the orientation zone and with a means for driving the extruder.
